(19) United States
(12) Patent Application Publication
(10) Pub. No.: US 2021/0349885 A1
(43) Pub. Date: Nov. 11, 2021

(54) DOCUMENT AGGREGATION IN A DIGITAL TRANSACTION MANAGEMENT PLATFORM

(71) Applicant: DocuSign, Inc., San Francisco, CA (US)

(72) Inventors: DUANE ROBERT WALD, Kent, WA (US); ANDREW JAMES ASHLOCK, San Francisco, CA (US); JACOB SCOTT MITCHELL, Richmond, VA (US); ERIC M. ZENZ, Mercer Island, WA (US); MARGUERITE BOUSCAREN, San Francisco, CA (US); SAUL ADAMS AGUILAR, Redwood City, CA (US); CHRISTOPHER SHANE DURHAM, Seattle, WA (US)

(21) Appl. No.: 16/870,511

(22) Filed: May 8, 2020

(51) Int. Cl. G06F 16/23; G06F 16/21; G06F 16/93; G06F 21/62

(52) U.S. Cl. CPC G06F 16/2379; G06F 21/6209; G06F 16/93; G06F 16/21

(57) ABSTRACT

An electronic document service provides an interoperable network in which entities can come to agreement as peers. Entities can create a network of trusted accounts, enable sharing and collaboration within the network, enforce process settings of shared transactions, and enable customized levels of visibility into transactions for all entities involved. In embodiments, an agent server receives documents from suppliers to be executed within a network of the electronic document service. Each document corresponds to signing requirements and collection requirements. The agent server combines the documents into a single signing package based on the signing requirements associated with each document. The agent server provides the signing package for execution, and receives the executed signing package. The agent server extracts the individual signed documents from the executed signing package. Based on the collection requirements associated with each document, the agent server provides each extracted signed document to the corresponding supplier.

### BACKGROUND

This description generally relates to electronic document services, and specifically to document aggregation in a multi-provider environment.

In current systems, agent servers provide signing users envelopes of documents for execution. Many envelopes include documents required by multiple suppliers. However, using current systems, it is difficult to efficiently distribute executed documents to the correct supplier. Further, current systems are not able to properly cope with the signing and collection requirements of different suppliers when the documents of the different suppliers are aggregated into a single envelope. Finally, in current systems, all executed documents are often routed to all suppliers that are associated with at least one document in the electronic envelope. This may cause liability issues for agents who incorrectly distribute confidential information and/or the suppliers that receive the confidential information without access privileges.

### SUMMARY

The electronic document service provides an interoperable network in which organizations can come to agreement as peers. Through the network, organizations can create a network of trusted accounts, enable sharing and collaboration within the network, enforce process settings of shared transactions, and enable customized levels of visibility into transactions for all parties involved.

In particular, networks can be used to provide signing packages (e.g., envelopes) to recipients that include documents from multiple parties (“suppliers”) and conform to the unique requirements of each supplier. Requirements may include security and authentication requirements, signing requirements, collection requirements, or any other suitable requirement. In this way, the electronic document service helps ensure that recipients execute documents in a way that meets the requirements of all parties associated with an envelope, while providing recipients (e.g., an entity that electronically signs the documents in the envelope) a simple and efficient signing experience. It should be noted that “electronically signing” and “signing” may be used interchangeably through the description for the purposes of simplicity.

In some embodiments, an agent server receives documents from multiple suppliers that are to be executed by a user within a shared network of the electronic document service. Each document corresponds to a set of signing requirements and a set of collection requirements. The agent server combines the set of documents into a single signing package (e.g., an electronic envelope) based on the set of signing requirements associated with each document. The agent server provides the signing package to the user for execution, and receives the executed signing package after the user has electronically signed the documents in the signing package. The agent server extracts the individual signed documents from the executed signing package. Based on the set of collection requirements associated with each document, the agent server provides each extracted signed document to the corresponding supplier. The agent server may also provide additional information captured during document execution to the corresponding suppliers based on the collection requirements, such as who signed the document, when was the document signed, when was the signing package fully executed, which device was used for execution, and the like.

### BRIEF DESCRIPTION OF THE DRAWINGS

FIG. 1 illustrates a diagram of a system environment of an electronic document service, according to one embodiment.

FIG. 2 illustrates a block diagram of the electronic document service, according to one embodiment.

FIG. 3 illustrates an example user interface of the electronic document service for configuring the settings of a network, according to one embodiment.

FIG. 4 illustrates an example user interface of the electronic document service for joining a network, according to one embodiment.

FIG. 5A illustrates an example user interface of the electronic document service for creating an envelope, according to one embodiment.

FIG. 5B illustrates an example user interface of the electronic document service for associating the envelope with suppliers, according to one embodiment.

FIG. 6 is a flowchart of a method for creating and distributing an envelope, according to one embodiment.

The figures depict various example embodiments of the present technology for purposes of illustration only. One skilled in the art will readily recognize from the following description that other alternative embodiments of the structures and methods illustrated herein may be employed without departing from the principles of the technology described herein.

### DETAILED DESCRIPTION

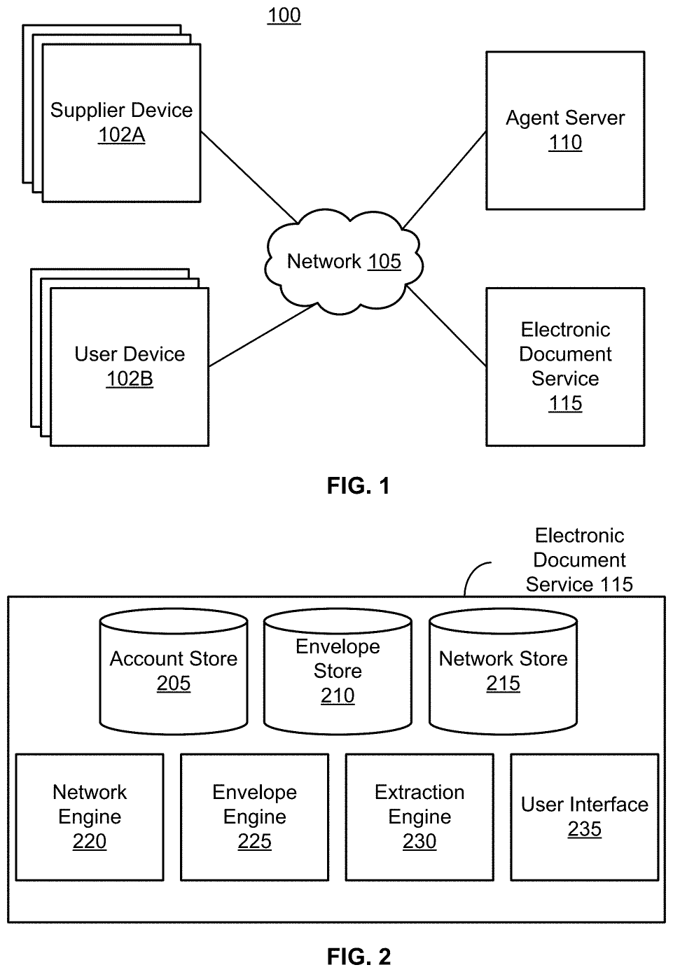

FIG. 1 illustrates a diagram of a system environment 100 of an electronic document service 115, according to one embodiment. The system environment 100 shown by FIG. 1 includes supplier devices 102A, user devices 102B, a network 105, an agent server 110, and an electronic document service 115. In alternative configurations, different and/or additional components may be included in the system environment 100.

The system environment 100 described herein can be implemented within an online document system, a document execution system, or any type of digital transaction management platform. It should be noted that although description may be limited in certain contexts to a particular environment, this is for the purposes of simplicity only, and in practice the principles described herein can apply more broadly to the context of any digital transaction management platform. Examples can include but are not limited to online signature systems, online document creation and management systems, collaborative document and workspace systems, online workflow management systems, multi-party communication and interaction platforms, social networking systems, marketplace and financial transaction management systems, or any suitable digital transaction management platform.

Suppliers include any entity that provides documents for execution, such as individuals, organizations, companies, accounts, and the like. Suppliers create networks, configure network requirements, manage signing and collection requirements, create and provide electronic documents for execution, receive executed documents, and the like, through one or more supplier devices 102A. A supplier device 102A may be one or more computing devices capable of transmitting and/or receiving data over the network 105. The supplier device 102A may be a conventional computer (e.g., a laptop or desktop), a cellphone, or a similar device. The supplier device 102A enables a supplier to create and/or provide documents for execution to the electronic document service 115. After the electronic document service 115 receives an indication that one or more electronic documents in an electronic envelope have been executed, the supplier device 102A notifies the supplier of the execution based on the signing and/or collection requirements of the supplier. In some embodiments, the supplier device 102A includes a user interface that displays the executed documents.

Recipients include any entity that receives envelopes, such as a signing user, any user associated with a signing account, an organization or company, and the like. Recipients receive, review, and/or execute documents within envelopes through one or more user devices 102B. A user device 102B may be one or more computing devices capable of transmitting and/or receiving data over the network 105. The user device 102B may be a conventional computer (e.g., a laptop or desktop), a cellphone, or a similar device. The user device 102B enables recipients to receive, review, and execute envelopes via the electronic document service 115 and through a user device 102B. In some embodiments, a user device 102B includes a user interface that displays documents for execution.

The network 105 transmits data within the system environment 100. The network 105 may be a local area and/or wide area network using wireless and/or wired communication systems, such as the Internet. In some embodiments, the network 105 transmits data over a single connection (e.g., a data component of a cellular signal or Wi-Fi), and/or over multiple connections. The network 105 may include encryption capabilities to ensure the security of user data. For example, encryption technologies may include secure socket layers (SSL), transport layer security (TLS), virtual private networks (VPNs), and Internet Protocol security (IPsec), among others.

An agent server 110 may be a server of an entity that operates as an intermediary between suppliers and recipients, such as an agent or advisor. Through the agent server 110 and via the electronic document service 115, agents may compile and provide envelopes to user devices 102B for execution. In addition, agents may join and create networks of trusted accounts, create documents and document templates for execution, manage transactions, and the like, through the agent server 110. In some embodiments, the electronic document service 115 and the agent server 110 are implemented within different networks and on different sets of servers, while in other embodiments, the electronic document service 115 and the agent server 110 are implemented within the same server.

### Electronic Document Service

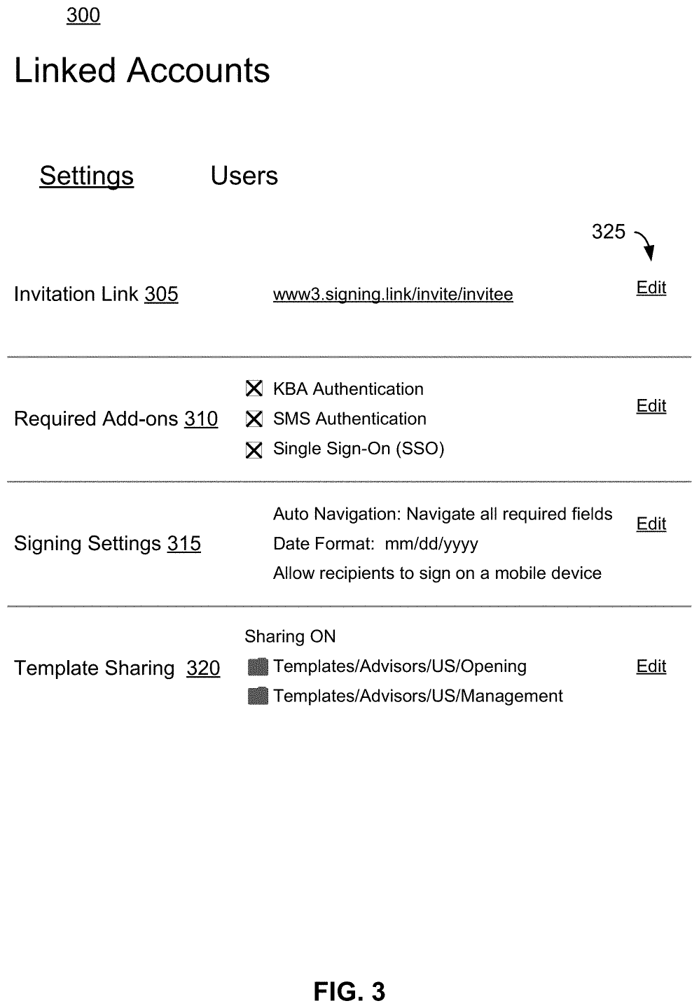

Through the electronic document service 115, an entity may compile an envelope of documents that each conform to the requirements of a corresponding supplier. In addition, through the electronic document service 115, parties are able to extract individual executed documents from envelopes, and distribute the extracted documents to suppliers based on the requirements associated with each document. Requirements may include security and authentication requirements, signing requirements, and/or collection requirements, discussed in detail below with reference to FIG. 2. The electronic document service 115 enables entities to create and join networks of entities. Networks can include accounts of suppliers, agents, recipients, or any other suitable entity within the electronic document server 115. Account holders may link an account to the network if the account settings of the account meet the network requirements established by the entity that created the network, entities that are hosts of the network, admins of the network, and the like. For example, for an agent to link an account to a network of a supplier, the account settings of the agent's account must meet the network requirements set by the supplier. When the agent's account is linked to the supplier's network, the agent may send envelopes to recipients on the supplier's behalf. Alternatively, or additionally, an agent's account may be linked to a supplier's network without meeting any or all of the network settings. Instead, the agent's account may be required to meet a set of requirements at a transaction level. For example, the agent may be able send a first envelope through an account with a first set of documents through the network based on the requirements associated with the first set of documents. However, the agent may not be able to send a second envelope with a second set of documents through the same account and through the same network based on the requirements associated with the second set of documents.

An envelope may include documents from multiple suppliers, and may be sent to a recipient by an agent on behalf of the multiple suppliers. To compile and distribute the envelope, the agent may be required to have an account linked to a network with each of the suppliers. In some embodiments, the agent and each of the suppliers may have accounts linked to a single network, while in other embodiments, the agent may have an account linked to networks associated with one or more subsets of the supplies. In some embodiments, the network requirements that the account settings of the agent must satisfy may be set by each of the networks associated with the envelope, each of the suppliers associated with the envelope, and the like, such that the execution of each document in the envelope conforms to the requirements set by each supplier.

FIG. 2 is a block diagram of an architecture of the electronic document service 115, according to one embodiment. The electronic document service 115 shown in FIG. 2 includes an account store 205, an envelope store 210, a network store 215, a network engine 220, an envelope engine 225, an extraction engine 230, and a user interface 235. In other embodiments, the electronic document service 115 may include additional, fewer, and/or different components.

The electronic document service 115 maintains information associated with accounts of the electronic document service in the account store 205. Entities may be associated with one or more accounts with the electronic document service 115. Using an account of the electronic document service 115, an entity may create and/or distribute documents, create document templates and/or envelope templates, execute documents, create and join networks, configure account settings, and the like. Each account may include information about the account holder, such as information about the individuals with access to the account (name, position, department, etc.), the organization associated with the account (employer, organization type, etc.), age of the account, frequency of account use, log of past account transactions, and the like. Account information may also include account settings, such as account type (e.g., business account versus personal account), security and authentication settings, signing settings, collection settings, and the like. Each account may have different account settings based on the usage needs of the account holder. For example, an agent may have a first account for a legal department, a second account for a human resources department, and a third account for personal use, each of which are associated with different account settings.

Security and authentication settings govern recipient access to envelopes and/or individual documents. Examples of security settings include login requirements, password requirements, session timeouts, and the like. Examples of authentication settings include phone authentication, short message service (SMS) authentication, knowledge based authentication (KBA), identity verification (IDV), access code requirements, single sign-on requirements, authentication triggers (e.g., how often authentication is required), and the like. Signing settings govern recipient signing behavior. Examples of signing settings may be based on watermark configurations, document and/or field navigation, mobile device use, signing responsibility (e.g., who can sign among individuals associated with an organization), document editing, signature pad type, date format, time format, legal disclosure language, and the like. For example, users may be allowed to edit a document to complete one or more fields, may be required to view all legal language associated with the document, and may be required to include a date and initials when signing. Collection settings govern which information is provided back to the sender and/or document supplier upon execution of the envelope. Collection settings may be based on the individual documents included in the envelope, the metadata collected during delivery and envelope execution, completion notifications, and the like. For example, a collection setting of a supplier may require a notification after each document is executed, a certification of completion and a log of execution progress in addition to the executed documents.

Account information may also include a set of requirements the account holder requires other accounts to satisfy before joining a network of the account holder, compiling and distributing envelopes on behalf of the account holder, and the like. When an account holder has multiple networks that are each configured through the same account, the account holder may set different requirements for each network. Requirements include security and authentication requirements, signing requirements, collection requirements, and the like. These requirements may be the same, similar, or different than the corresponding settings of the account. Requirements may include a range of acceptable values and/or thresholds that accounts may satisfy to join a network. For example, the signing settings of a first account may include a date format of month/day/year, but the signing requirements of the first account may allow other accounts in the network to have signing settings with date formats of month/date/year or year/month/date.

Alternatively, or additionally, the account information may include a set of requirements at a transaction level. In these embodiments, a first account holder may link their account to a network of a second account holder without meeting the set of requirements associated with the network, and/or the network may not be associated with a set of requirements. Instead, the second account holder may require accounts (e.g., the account of the first account holder) to meet a set of requirements before transacting with the network of the second account holder. As an example, the first account holder may link an account to the network of the second account holder without meeting a set of requirements. However, the first account holder may not be able to add documents of the second account holder to an envelope, and/or send documents of the second account holder to a recipient, without first meeting the set of requirements of the second account holder.

Envelopes are maintained in the envelope store 210. Senders provide documents to recipients via envelopes. Envelopes may include documents from more than one supplier, and the sender may be one of the one or more suppliers or a third-party entity working as an intermediary, such as an advisor or agent. Electronic envelopes include recipient information, documents, and document fields that indicate which fields the recipient needs to complete upon execution. Envelopes may also include information about the sender, document supplier, security and/or authentication requirements, signing requirements, collection requirements, network(s) through which the envelope is being sent, and the like. The requirements may be associated with the envelope generally, or may be specific to particular documents within the envelope. For example, each document in the envelope may have unique signing requirements based on the content of the document, and the envelope may be associated with a set of collection requirements based on the aggregate collection requirements of each document within the envelope. Each envelope may also include one or more tags that identify which recipients are responsible for execution of each document, which supplier is associated with each document, and the like. Tags may be pointers to an account of the corresponding recipient, agent, and/or supplier.

The envelope store 210 may also store envelope templates. Templates may be used as blueprints for repeatable transactions between suppliers, agents, signing users, or a combination thereof. An envelope template may include a set of documents that are historically grouped in the same envelope, historically associated with a particular transaction type, frequently sent to the same recipients, and the like. An envelope template may include recipient information, document fields, messages, signing instructions, collection requirements, and the like. Senders may select an envelope template for use in creating an envelope to send to recipients. Alternatively, or additionally, senders may use document templates in the creation of one or more documents (such as documents to be included within an envelope). A document template may include document fields, legal disclosure language, recipient information, and the like. Accordingly, a sender may use one or more document templates to create a set of documents each with a set of fields and signing instructions specified in the document templates, may include an envelope template to create an envelope that includes signing requirements specified in the document templates, may include the set of documents within the envelope, and may send the envelope to a set of recipients identified by one or both of the document templates and the envelope template.

In some embodiments, envelope templates and envelope documents may be shared within and across networks. For example, an account holder of an account linked to a network may publish envelope templates and/or envelope documents to the network such that the other accounts linked to the network may access the published envelope templates and/or envelope documents. In some embodiments, all accounts linked to the network may publish envelope templates and/or envelope documents to the network. In other embodiments, a predetermined set of accounts may publish envelope templates and/or envelope documents to the network (e.g., based on the set of requirements of the account holder that created the network).

The electronic document service 115 maintains information associated with networks in the network store 215. For each network, the electronic document service 115 may store the requirements that must be satisfied to join the network. The network store 215 also stores information detailing which accounts are linked to the network, which account holders created the network, signing and collection requirements of documents and/or envelopes shared through the network, relationships between network members, and the like. The network store 215 may also store an activity log for each network detailing which envelopes have been distributed through the network, progress statuses of envelopes, and the like.

The network engine 220 determines whether an account is eligible to join a network. For instance, the network engine 220 identifies the requirements of the entity that created the network and/or admins of the network, and compares the requirements to the account settings of the account. In some embodiments, a network may enable a range of settings for accounts linked to the network. For example, a network may require that accounts have either SMS authentication or KBA enabled. If the account meets or exceeds the requirements of the network, the network engine 220 provides the account holder an indication that the account is eligible to join the network. If the account does not meet the requirements, the network engine 220 may identify which requirements are not met, may identify remedial actions that can be performed so that the account meets or exceeds each of the requirements, and may provide the remedial actions that when taken cause the account to satisfy the requirements to the account holder (for instance, via one or more interface elements that, when interacted with, causes the remedial actions to be performed). Examples of remedial actions may include upgrading the account, enabling or disabling one or more account settings (such as single sign-on or template sharing), modifying legal disclosure language (such as the electronic record and signature consent disclosure), and the like.

The network engine 220 may also determine that a remedial action may cause an account to no longer meet the requirements of a different network with which the account is already linked. In these embodiments, the network engine 220 may notify the account holder and require explicit confirmation from the account holder before performing the remedial action. For example, a first network may require KBA to be enabled by an account, and an account of an account holder may have KBA disabled. The network engine 220 determines that the account settings of the account need to be modified to enable KBA in order to link the account with the first network. However, in this example, the account is already linked to a second network that requires KBA to be disabled. The network engine 220 notifies the account holder that if KBA is enabled, the account will no longer be linked with the second network. The network engine 220 also provides the account holder with an interface element that allows the account holder to explicitly confirm whether the account settings will be modified to enable KBA, and to explicitly confirm that the account holder consents to the account being unlinked with the second network. In addition, the network engine 220 may identify alternative remedial actions that may be performed that would enable the account to be linked to both the first network and the second network. Continuing with the above example, the network engine 220 may determine that the first network requires accounts to have either KBA enabled or SMS authentication enabled. Based on this determination, the network engine 220 may identify a remedial action that includes enabling SMS authentication on the account so that the account may be linked to both the first and second network.

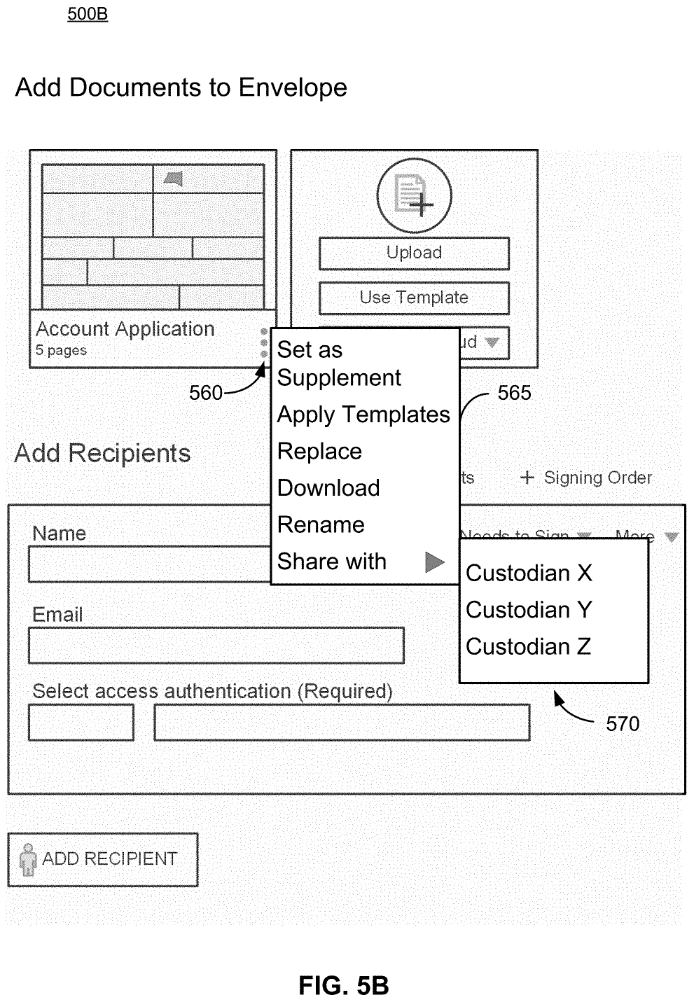

The envelope engine 225 compiles and distributes envelopes to recipients. The envelope engine 225 receives or accesses a set of documents to be included in an envelope. In some embodiments, the envelope engine 225 automatically associates documents with suppliers. For example, the envelope engine 225 may associate a supplier with a document based on characteristics of the document and known characteristics of documents supplied by a particular supplier. Known document characteristics may include a layout of the document, logos on the document, types of clauses within the document, requirements associated with the document, content within the document, and the like. The envelope engine 225 may associate documents with suppliers by tagging documents in the envelope. Tags may be pointers to accounts of the corresponding suppliers, and/or may include information identifying or associated with the corresponding suppliers. Alternatively, or additionally, an agent or supplier may associate documents with suppliers using a user interface of the electronic document service 115, discussed in detail below with reference to FIG. 5B.

When a document is associated with a supplier, the document may automatically be associated with the requirements of the supplier, such as the signing and collection requirements of the supplier. The envelope engine 225 compiles the documents within an envelope based on the security and authentication requirements and signing requirements of each document in the set. For example, for a recipient to access and execute a first document of a first supplier in an envelope, the recipient may be required to login to the electronic document service 115 using two-factor authentication, and for the recipient to access and execute a second document of a second supplier in the envelope, the recipient may be required to view and accept legal disclosure language set by the second supplier. In this example, the envelope engine 225 compiles the envelope such that recipients are required to login using two-factor authentication, and to view and accept the legal disclosure language set by the second supplier before executing the first and second documents.

In some embodiments, when a document and/or envelope is associated with more than one supplier, the envelope engine 225 may determine an aggregate set of requirements for the document and/or envelope by combining the individual requirements associated with the documents and envelope. In some embodiments, the suppliers associated with the document and/or envelope collectively determine which set of requirements will be applied to the document and/or envelope. For example, the suppliers may agree on which legal disclosure language is used, which authentication methods are accepted, and how recipients navigate through each document.

The extraction engine 230 determines which executed documents are provided to each supplier associated with the envelope, which metadata is collected during envelope execution, how metadata is distributed to suppliers, and the like. In some embodiments, the extraction engine 230 makes these determinations based on the collection requirements associated with each document. For example, a first supplier associated with an envelope may require status updates for each document in the envelope, copies of all executed documents, and a certificate of envelope completion. A second supplier associated with the envelope may only require the return of the executed documents that they provided, and may explicitly request to not receive any metadata or certificates of completion. In this example, the extraction engine 230 provides executed documents and metadata to the first supplier, and provides only the executed documents (without metadata) to the second supplier. The extraction engine 230 may provide executed documents and corresponding metadata to suppliers based on the tags associated with each document in the envelope. For example, the extraction engine 230 may automatically notify an account of a supplier when a document has been executed, and may automatically provide the account with the executed document, based on a document tag associated with the document that specifies that the supplier is to be notified and the executed document is to be returned.

The user interface 235 allows account holders to provide documents for execution, compile and distribute envelopes, join and create networks, receive and execute documents, using various elements of the user interface 235. The user interface 235 also allows account holders to modify account settings, configure network requirements, connect with other account holders, and the like. Further, the user interface 235 may allow recipients that do not hold accounts with the electronic document service 115 to receive and execute envelopes for execution.

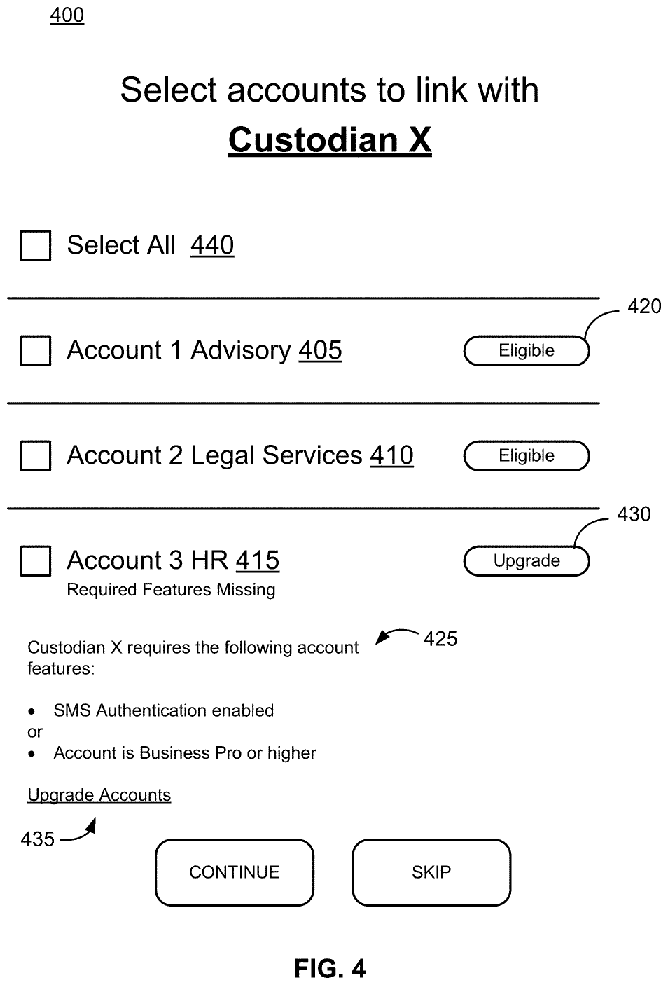

FIG. 3 illustrates an example user interface 300 of the electronic document service 115 for configuring the settings of a network. Through the user interface 300, an account holder may configure the settings of a network that the account holder created, is an admin of, is associated with, or the like. Examples of network settings may include how an account may access the network, network requirements that accounts must satisfy before joining the network, and document requirements that documents are subject to when shared through the network. In the embodiment of FIG. 3, the settings interface 300 includes an invitation link 305, required add-ons 310, signing settings 315, and template sharing settings 320. The account holder may modify the settings using one or more interactive interface elements, such as the edit interface element 325.

Account holders may request access to a network using an invitation link 305 that is provided to account holders by an owner, admin, host, or other entity associated with the network. The invitation link 305 may be provided to account holders through the electronic document service 115, or through an external application, such as through a third-party email application or third-party messaging application. The required add-ons 310 include the security and authentication requirements of the network. The required add-ons 310 shown include KBA authentication, SMS authentication, and single sign-on settings. The signing settings 315 shown include auto-navigation, a required date format, and settings to allow recipients to sign documents on mobile devices. The template sharing settings 320 indicates that template sharing is enabled, and includes templates from two particular folders may be shared with accounts linked to the network.

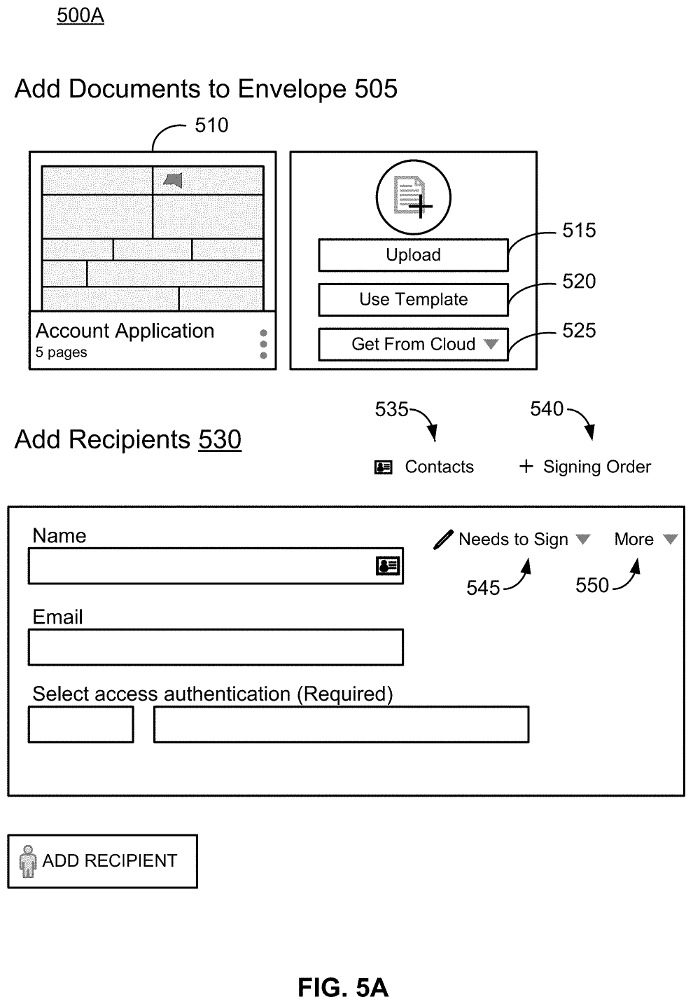

FIG. 4 illustrates an example user interface 400 of the electronic document service 115 for joining a network. Through the user interface 400, account holders may link one or more of their accounts to a network. Once the account holder links an account to the network, the account holder may compile and distribute envelopes on behalf of parties that are linked to the network, such as a supplier that created the network, suppliers that joined the network, and the like.

As shown in FIG. 4, the account holder has three accounts, namely an advisory account 405, a legal services account 410, and an HR account 415. Each of these accounts may be associated with different account settings, which may be based on the account holder's usage requirements of each account. The network engine 220 determines which of the accounts are eligible to join the network based on the requirements of the network and the account settings of each of the accounts. Based on this determination, the user interface 400 provides the account holder with an indication of whether each account is eligible to join the network. For example, the user interface 400 includes an eligible icon 420 that indicates the advisory account 405 is eligible to join the network. When an account is ineligible, the user interface 400 may provide an interface icon that indicates the account is ineligible to join the network. The user interface 400 may also provide for display the account settings 425 that are required by the network and missing by the account. For example, in the illustration shown, the network requires linked accounts to have SMS authentication enabled or have an account type of Business Pro or higher, each of which is not included in the account settings of the HR account 415.

Alternatively, or additionally, the user interface 400 may provide an upgrade icon 430 that indicates the network engine 220 identified one or more remedial actions that may be performed to make the account eligible to join the network. For example, the upgrade icon 430 indicates that the network engine 220 identified one or more remedial actions that may be performed on the HR account 415 such that the HR account 415 may be linked to the network. In these embodiments, the user interface 400 may include an upgrade account interface element 435 that enables a user to upgrade the ineligible account based on the missing account settings 425 and the one or more remedial actions identified by the network engine 220. When the account holder selects the upgrade interface element 435, the one or more remedial actions may be provided to the account holder for display as selectable options.

In some embodiments, account holders may link some or all of their accounts with a network. In the user interface 400 shown, the account holder may link all accounts to the network with the select all interface element 440. In some embodiments, if not all accounts are eligible, then the select all interface element 440 may cause all eligible accounts to be selected. In other embodiments, if not all accounts are eligible and the user selects the select all interface element 440, the account holder may be required to upgrade all ineligible accounts before proceeding.

FIG. 5A illustrates an example user interface 500A of the electronic document service 115 for creating an envelope. Through the user interface 500A, account holders, such as agents, may compile and distribute envelopes to recipients for execution. Using a first portion 505 of the user interface 500A, agents may add documents to an envelope, edit and/or remove documents in an envelope, and configure document settings. In the example user interface 500A shown, the envelope includes a first document 510 (previewed within the first portion 505 of the user interface 500A). Additional documents may be added to the envelope using the one or more interactive interface elements. For example, agents may add additional documents to the envelope using the upload interface element 515. In some embodiments, the upload interface element 515 is used to retrieve locally stored documents, such as document stored on the agent server 110, a supplier device 102A, a user device 102B, etc. Alternatively, or additionally, documents may be added using the template interface element 520. For example, one or more templates may be retrieved via the template interface element 520, and one or more documents may be created using the retrieved templates and added to envelope. Alternatively, or additionally, documents may be added to the envelope using the cloud interface element 525 to access documents over the network 105. In embodiments where an account is required to meet a set of requirements at a transaction level, the network engine 220 may determine whether an agent may add each document to the envelope. The network engine 220 may also indicate one or more reasons a document may not be added to the envelope (e.g., which requirements are not met by the account of the agent compiling the envelope). In response, the agent may compile the envelope without the document that may not be added, upgrade the account, and/or modify the account setting of the account, and the like. Recipients may be added to the envelope using a second portion 530 of the user interface 500A. Additionally, signing requirements, security requirements, and/or authentication requirements may be added to the envelope and/or individual documents through the second portion 530 of the user interface 500A. Using various interface elements of the user interface 500A, agents may add recipients from a set of contacts 535 and/or a signing order 540 to the envelope. Agents may also flag recipients that need to sign, for example using a “needs to sign” interface element 545. Additionally, agents may configure envelope settings with one or more additional user interface elements, such as the “more” interface element 550. Using the more interface element 550, agents may add authentication access codes, draft messages to recipients, access advanced settings, and the like. In embodiments where an account is required to meet a set of requirements at a transaction level, the network engine 220 may determine whether the agent may distribute the envelope before the envelope is distributed to each of the recipients. For example, in response to the agent submitting the envelope for distribution to a recipient, the network engine 220 may identify one or more documents in the envelope that may not be distributed by the agent based on the set of requirements of the document supplier. In these embodiments, the agent may be required to remove the one or more identified documents from the envelope, upgrade the account, modify one or more account settings of the account, and the like.

FIG. 5B illustrates an example user interface 500B of the electronic document service 115 for associating envelope documents with suppliers. Documents and document settings of each document in an envelope can be modified using an interactive interface element 560 of the user interface 500B. Examples of modifications 565 include setting the document as a supplement, applying a template to the document, replacing the document, downloading the document, renaming the document, editing the document, and sharing the document.

The sharing setting enables documents to be associated with suppliers. For example, a document may be associated with one or more suppliers, including the supplier that provided the document and suppliers that require the document upon execution. As previously discussed, the envelope engine 225 may automatically associate documents with document suppliers. Alternatively, or additionally, agents may manually associate documents with suppliers or edit automatic associations. For example, agents may tag a document with a supplier from a list of suppliers 570. The list of suppliers 570 may include suppliers associated with the envelope, suppliers in one or more networks of the agent creating the envelope, and the like.

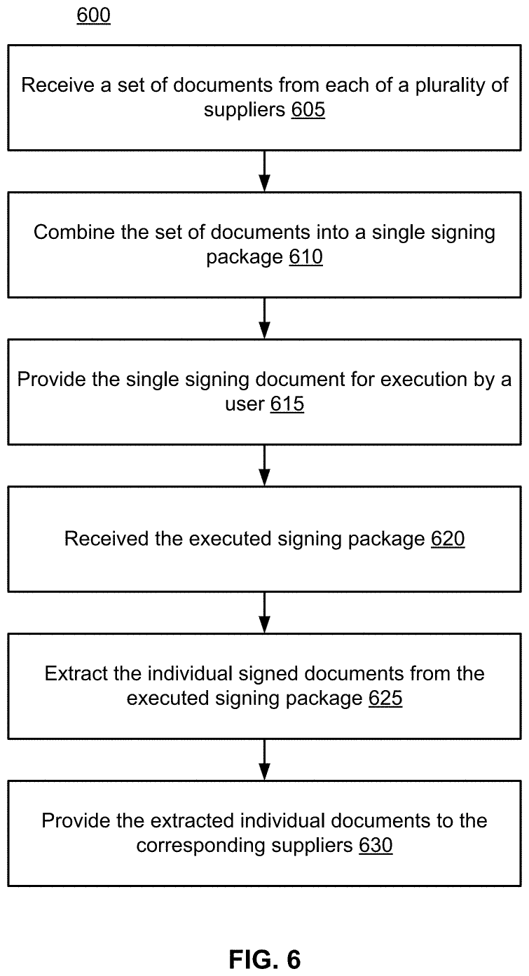

FIG. 6 is a flowchart of a method 600 for creating and distributing an electronic signing package (i.e., an envelope). In the method 600 shown, the agent server 110, via the electronic document service 115, receives 605 a set of documents to be executed by a user within a shared network of the electronic document service 115. Each document in the set of documents corresponds to a set of signing requirements and a set of collection requirements. For example, a signing requirement of a document may specify language that is displayed to the user at the time the user executes the corresponding document. Further, a collection requirement of a document may specify information that is captured at the time of execution and provided back to the corresponding supplier of the document.

The agent server 110, via the electronic document service 115, combines 610 the set of documents into a single signing package based on the set of signing requirements associated with each document. The agent server 110 provides 615 the single signing package for execution to the user. The agent server 110 receives 620 the executed signing package, and extracts 625, via the electronic document service 115, the individual signed documents from the executed signing package. The agent server 110 provides 630 the extracted signed documents to the corresponding suppliers based on the set of collection requirements. In some embodiments, to combine the sets of documents into a single signing package, the agent server 110, via the electronic document service 115, assigns a tag associated with a supplier to each document based on the corresponding set of collection requirements. In these embodiments, the agent server 110 extracts and routes the individual signed documents based on the tags associated with each document.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, by an agent server, from each of a plurality of suppliers, a set of documents to be executed by a user within a shared network of an electronic document service, each document corresponding to a set of signing requirements and a set of collection requirements;
combining, by the agent server via the electronic document service, the sets of documents into a single signing packing based on the set of signing requirements associated with each document;
providing, by the agent server, the single signing packing for execution to the user;
receiving, by the agent server, the executed signing package;
extracting, by the agent server via the electronic document service, individual signed documents from the executed signing package; and
providing, by the agent server, the extracted individual signed documents to the corresponding suppliers based on the set of collection requirements.

2. The method of claim 1, wherein combining the set of documents into the single signing packing comprises: assigning, by the agent server via the electronic document service, to each document in the sets of documents, a tag associated with a supplier of the document;
wherein extracting the individual signed documents from the executed signing package comprises extracting the individual signed documents based on the tags associated with each document in the sets of documents.

3. The method of claim 1, wherein the electronic document service is implemented within the agent server.

4. The method of claim 1, wherein the electronic document service is implemented within a server separate from the agent server.

5. The method of claim 1, wherein further comprising:
determining, by the agent server, that the user does not satisfy one or more signing requirements of the sets of signing requirements; and
providing, by the agent server, one or more interface elements for display to the user, the one or more interface elements configured to, when selected, perform one or more remedial actions based on the one or more signing requirements that the user does not satisfy.

6. The method of claim 5, wherein determining the user does not satisfy one or more signing requirements comprises determining that an account of the user does not satisfy the one or more signing requirements.

7. The method of claim 1, wherein the set of signing requirements for a document of the sets of documents specifies language that is displayed to the user at the time the user electronically signs the document.

8. The method of claim 1, wherein the set of collection requirements of a document of the sets of documents specifies information that is captured at the time of execution of the document and provided back to the corresponding supplier of the document.

9. A non-transitory computer-readable storage medium containing computer program code that, when executed by a processor, causes the processor to perform steps comprising:
receiving, by an agent server, from each of a plurality of suppliers, a set of documents to be executed by a user within a shared network of an electronic document service, each document corresponding to a set of signing requirements and a set of collection requirements;
combining, by the agent server via the electronic document service, the sets of documents into a single signing packing based on the set of signing requirements associated with each document;
providing, by the agent server, the single signing packing for execution to the user;
receiving, by the agent server, the executed signing package;
extracting, by the agent server via the electronic document service, the individual signed documents from the executed signing package; and
providing, by the agent server, the extracted individual signed documents to the corresponding suppliers based on the set of collection requirements.

10. The non-transitory computer-readable storage medium of claim 9, wherein combining the set of documents into the single signing packing comprises: assigning, by the agent server via the electronic document service, to each document in the sets of documents, a tag associated with a supplier of the document;
wherein extracting the individual signed documents from the executed signing package comprises extracting the individual signed documents based on the tags associated with each document in the sets of documents.

11. The non-transitory computer-readable storage medium of claim 9, wherein the electronic document service is implemented within the agent server.

12. The non-transitory computer-readable storage medium of claim 9, wherein the electronic document service is implemented within a server separate from the agent server.

13. The non-transitory computer-readable storage medium of claim 9, wherein the program code, when executed by the processor, causes the processor to perform further steps comprising:
determining, by the agent server, that the user does not satisfy one or more signing requirements of the sets of signing requirements;
providing, by the agent server, one or more interface elements for display to the user, the one or more interface elements configured to, when selected, perform one or more remedial actions based on the one or more signing requirements that the user does not satisfy.

14. The non-transitory computer-readable storage medium of claim 9, wherein the set of signing requirements for a document of the sets of documents specifies language that is displayed to the user at the time the user electronically signs the document.

15. The non-transitory computer-readable storage medium of claim 9, wherein the set of collection requirements of a document of the sets of documents specifies information that is captured at the time of execution of the document and provided back to the corresponding supplier of the document.

16. A system comprising:
a hardware processor; and
a non-transitory computer-readable medium containing instructions that, when executed by the hardware processor, cause the hardware processor to:
receive, by an agent server, from each of a plurality of suppliers, a set of documents to be executed by a user within a shared network of an electronic document service, each document corresponding to a set of signing requirements and a set of collection requirements;
combine, by the agent server via the electronic document service, the sets of documents into a single signing packing based on the set of signing requirements associated with each document;
provide, by the agent server, the single signing packing for execution to the user;
receive, by the agent server, the executed signing package;
extract, by the agent server via the electronic document service, the individual signed documents from the executed signing package; and
provide, by the agent server, the extracted individual signed documents to the corresponding suppliers based on the set of collection requirements.

17. The system of claim 16, wherein the electronic document service is implemented within the agent server.

18. The system of claim 16, wherein the electronic document service is implemented within a server separate from the agent server.

19. The system of claim 16, wherein the set of signing requirements for a document of the sets of documents specifies language that is displayed to the user at the time the user electronically signs the document.

20. The system of claim 16, wherein the set of collection requirements of a document of the sets of documents specifies information that is captured at the time of execution of the document and provided back to the corresponding supplier of the document.
